(19) United States
(12) Patent Application Publication
(10) Pub. No.: US 2007/0258608 A1
(43) Pub. Date: Nov. 8, 2007

(54) Headphone

(76) Inventors: Wolfgang Neihoff, Wedermark (DE); Axel Grell, Burgdorf (DE)

Correspondence Address: REED SMITH, LLP;ATTN: PATENT RECORDS DEPARTMENT, 599 LEXINGTON AVENUE, 29TH FLOOR, NEW YORK, NY, 10022-7650, US

(21) Appl. No.: 11/662,466

(22) PCT Filed: Sep. 9, 2005
(86) PCT No.: PCT/EP05/09696

§ 371 Date: May 2, 2007

(30) Foreign Application Priority Data
Sep. 10, 2004 (DE) 10 2004 044 280.0

(51) Int. Cl. H04R 5/02

(52) U.S. Cl. 381/309

(57) ABSTRACT

There is provided a headphone having an active interference sound compensation unit for the compensation of interference sound. In addition thereto the headphone has a wireless receiver for wirelessly receiving an audio signal to be reproduced. The provision of the wireless receiver achieves the result that information or audio signals can be transmitted directedly or intentionally to the wearer of the headphone without the signals being compensated away by the interference sound compensation unit.

### CROSS-REFERENCE TO RELATED APPLICATIONS

This application claims priority of International Application No. PCT/EP2005/009696, filed Sep. 9, 2005 and German Application No. 10 2004 044 280.0, filed Sep. 10 2004, the complete disclosures of which are hereby incorporated by reference.

### BACKGROUND OF THE INVENTION

a) Field of the Invention

The present invention concerns a headphone and a headset arrangement.

b) Description of the Related Art

The use of active noise compensation units in headphones is known for example from the Sennheiser headphones HDC 451, PXC 250 and HMEC 25. The interference sound or ambient sounds are picked up by a microphone and fed to the active interference sound compensation unit whereby that interference sound is compensated in such a way that the interference sound is only softly perceived. The use of noise-compensated headphones of that kind are known in the cockpit of an aircraft for suppressing flight noise and headphones which can be used in a private context for suppressing flight noise in a passenger cabin. In addition headsets with such noise compensation can also be provided in an automobile in order to be able to telephone in the automobile with as low a level of noise as possible.

Usually noise-compensated headphones of that kind are connected by way of a conventional headphone connection, by way of which the audio signal to be transmitted is inputted. That audio or foreign signal can represent for example an entertainment program or music on board an aircraft or a telephone signal. That audio signal is fed in by way of the amplifier disposed in the noise compensation unit, correspondingly amplified and outputted together with the signals of the noise compensation unit.

Headset arrangements or headsets are also known, which besides the headphone also have a speech microphone or a boom microphone. A power supply is afforded either by an additional connection or by a battery supply. The active noise compensation unit in that case is connected to the headphone.

Apart from those cases in which actual bidirectional communication is to be made a possibility, there are also uses in which noise compensation is in the foreground. Examples in that respect are industrial noise protection, and listening to music in a noise-filled environment such as for example in trains or when mowing the lawn.

### OBJECT AND SUMMARY OF THE INVENTION

Therefore the primary object of the present invention is to provide a headphone or a headset arrangement having active noise compensation, wherein transmission or reproduction of audio signals is possible.

That object is attained by a headphone in accordance with the invention comprising an active interference sound compensation unit for active compensation of interference sound and a wireless receiver for wirelessly receiving an audio signal to be reproduced. The object is also achieved in accordance with the invention by a headset arrangement comprising an active interference sound compensation unit for active compensation of interference sound and a wireless receiver for wirelessly receiving an audio signal to be reproduced.

Thus there is provided a headphone having an active interference sound compensation unit for the compensation of interference sound. In addition thereto the headphone has a wireless receiver for wirelessly receiving an audio signal to be reproduced.

By virtue of the provision of the wireless receiver, items of information or audio signals can be passed directedly or intentionally to the wearer of the headphone without those signals being compensated away by the interference sound compensation unit.

In accordance with an aspect of the present invention both the active interference sound compensation unit and also the wireless receiver are disposed in the same housing in or on the headphone.

The present invention also concerns a headset arrangement having an active interference sound compensation unit for active compensation of interference sound. There is also provided a wireless receiver for wirelessly receiving audio signals to be reproduced.

The invention also concerns a headphone having an active interference sound compensation unit for the active compensation of interference sound and an information storage means for the storage and reproduction of audio signals.

The invention is based on the idea of implementing the receiver in or on the headphone or the headset arrangement, instead of an additional device for wirelessly receiving audio signals. This means that it is necessary to provide only one single device for active interference sound compensation and for wireless reception, and that enhances the level of wearing comfort.

Further configurations of the invention are set forth in the appendant claims.

The invention is described in detail hereinafter with reference to the drawing.

### BRIEF DESCRIPTION OF THE DRAWINGS

In the drawings:

FIG. 1 shows a diagrammatic view of a headphone according to the first embodiment;

FIG. 2 shows a diagrammatic view of a headphone according to the second embodiment; and

FIG. 3 shows a diagrammatic view of a headset arrangement according to the third embodiment.

### DESCRIPTION OF THE PREFERRED EMBODIMENTS

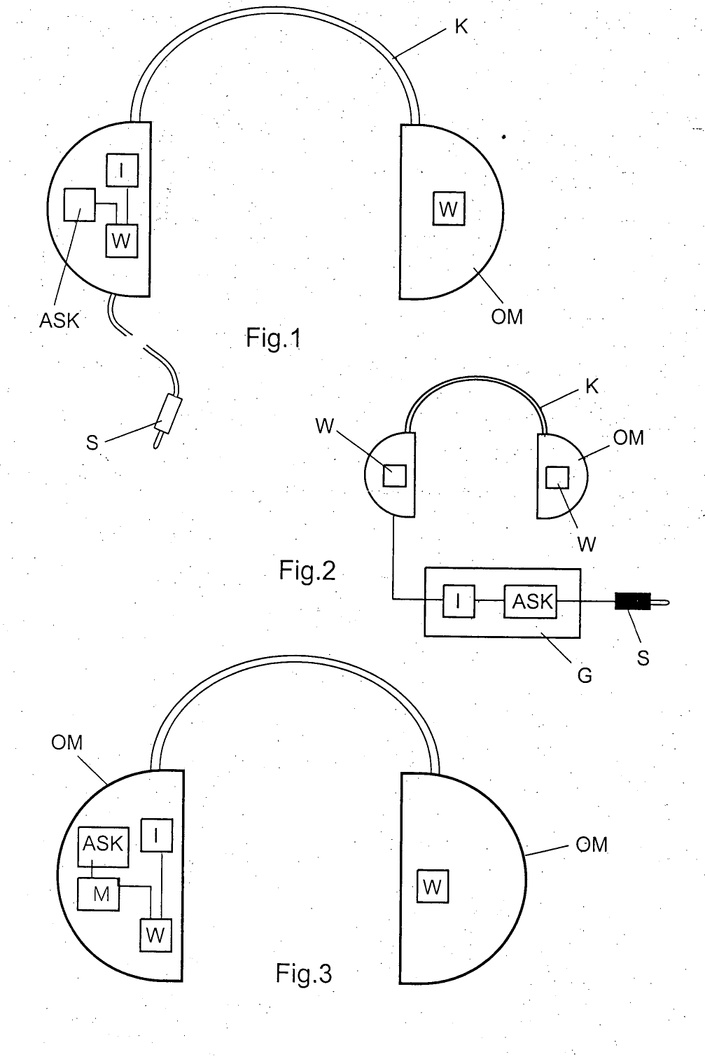

FIG. 1 shows a diagrammatic view of a headphone K in accordance with the first embodiment. The headphone K has two earpieces OM and a plug S. Arranged in one of the earpieces OM is an active interference sound compensation unit ASK, a wireless receiver I and a reproduction transducer W. Audio signals can be wirelessly transmitted to the headphone by the wireless receiver I. The provision of the wireless receiver I means that the plug S can be dispensed with, as now all audio signals to be reproduced are received by way of the wireless receiver. Accordingly the active interference sound compensation unit and a wireless receiver are embodied in a common housing.

FIG. 2 shows a diagrammatic view of a headphone in accordance with a second embodiment. The headphone again has two earpieces OM in which the reproduction transducers W are arranged. While in the headphone in accordance with the first embodiment the active interference sound compensation unit ASK and the wireless receiver I were embodied in one of the earpieces OM, these two units are implemented in an external housing G. As in the first embodiment it is possible to dispense with the plug if the audio signals to be reproduced are received by way of the wireless receiver I.

FIG. 3 shows a headphone in accordance with the third embodiment. The headphone of the third embodiment is essentially based on the headphone of the first embodiment. In addition to the wireless receiver I and the active interference sound compensation unit ASK an ear microphone M is also provided in the earpiece OM. Preferably the ear microphone M is arranged under the noise-compensated headphone in the ear channel. Accordingly speech pickup by that ear microphone is effected by way of the Eustachian tube which represents a communication between the mouth/pharynx cavity and the inner ear.

Electrical distortion correction which is necessary for good speech communication, that is to say frequency response adaptation, dynamic regulation and dynamic compression of the signal of the ear microphone OM is also implemented together with the active interference sound compensation unit. ASK. As an alternative thereto the distortion correction unit can be arranged in the headphone/sound protection cap housing. With such a headphone with ear microphone the active interference sound headphone can be used for a bidirectional communication, that is to say a headset arrangement can be embodied. While in the case of conventional (boom) microphones good interference sound treatment is possible only when the microphone is worn in the proximity of the mouth in order to implement an adequate signal in relation to the noise ratio for the called station, the third embodiment provides that the ear microphone OM is used to record the speech of a user in the headset arrangement. A problem of biological feedback of a person is further reduced by the use of the ear microphone OM. In the case of people who wear noise-compensated headphones, it happens that they talk more softly as subjectively they hear themselves markedly more softly and thus have no reason to speak more loudly.

As an alternative to the foregoing, a headset arrangement can also be provided with a boom microphone, instead of or in addition to the ear microphone.

In this respect the wireless receiver I in accordance with the first, second and third embodiment can be implemented wirelessly for example by DECT, by Bluetooth or by WLAN technology. As an alternative thereto the receiver I can also be implemented in the form of a radio receiver (FM/AM/DAB/DVB-T). In addition a radio transceiver is also possible as for example in the case of wireless headphones. As an alternative thereto an infrared or an ultrasound receiver is also possible.

While a wireless receiver I has been described in accordance with the first, second and third embodiment, as an alternative thereto or additionally thereto an information storage means can be provided for the storage of audio signals. An information storage means of that kind can be in the form of a semiconductor storage means, a semiconductor storage means with a source reduction function (AAC, MP3, etc.), in the form of a magnetic tape storage means or in the form of an opto-electronic storage means.

If both the information storage means and also the wireless receiver I are implemented together, the information storage means can be designed in such a way that reproduction from the information storage means is stopped if the wireless information receiver receives a message such as for example a telephone call. After the end of that message reproduction of the audio signals stored in the information storage means can be resumed.

The common implementation of the active interference sound compensation unit and the information receiver or the information storage means provides that given components such as for example a pre-amplifier, an output amplifier or the like can be used jointly, that is to say both for the noise compensation signal and also the audio signals, by the information receiver or the information storage means respectively, so that those components do not have to be duplicated. It is further possible to provide a common volume regulator, a common power supply and/or a common housing.

The use of the above-described headset arrangement with ear microphone and active interference sound compensation unit ASK in combination with the wireless receiver I means that it is possible to permit wireless bidirectional interference sound-compensated communication.

In the above-described headphone or the above-described headset arrangement, it is possible to provide an audio player such as for example an MP3 player in order to reproduce the audio data stored in the semiconductor storage means. As an alternative thereto the audio signals to be reproduced by the audio player can also be received by way of the wireless receiver. As an alternative thereto it is also possible to provide an insertion slot for a semiconductor memory card so that corresponding audio data can be previously stored on the memory card and the audio data stored thereon can then be reproduced by way of the audio player when the card is inserted into the insertion slot.

Integration of the MP3 player into the above-indicated headphone or into the above-indicated headset arrangement provides that for example a pre-amplifier, an output amplifier or the like can be used jointly by the audio player and the active interference sound compensation unit.

While the foregoing description and drawings represent the present invention, it will be obvious to those skilled in the art that various changes may be made therein without departing from the true spirit and scope of the present invention.

1-10. (canceled)

11. A headphone comprising:
an active interference sound compensation unit for active compensation of interference sound; and
a wireless receiver for wirelessly receiving an audio signal to be reproduced.

12. The headphone according to claim 11 wherein the active interference sound compensation unit and the wireless receiver are arranged in a common housing in or on the headphone.

13. The headphone according to claim 11 comprising a storage means for the storage of audio data and an audio player for reproducing the stored audio data or the audio signals received by the wireless receiver.

14. The headphone according to claim 13 wherein the audio player is an MP3 player.

15. A headset arrangement comprising:
an active interference sound compensation unit for active compensation of interference sound; and
a wireless receiver for wirelessly receiving an audio signal to be reproduced.

16. The headset arrangement according to claim 15 wherein the active interference sound compensation unit and the wireless receiver are arranged in a common housing in or on the headphone.

17. The headset arrangement according to claim 15 comprising an earpiece, wherein an ear microphone is arranged in the earpiece for picking up speech signals of a wearer.

18. The headset arrangement according to claim 15 comprising storage means for the storage of audio data and an audio player for reproduction of the stored audio signals or the audio signals received by the wireless receiver.

19. The headset arrangement according to claim 18 wherein the audio player is an MP3 player.

20. A headphone comprising:
an active interference sound compensation unit for the active compensation of interference sound; and
storage means for the storage of audio signals to be reproduced.

21. The headphone according to claim 20 wherein the interference sound compensation unit and the storage means are arranged in a common housing in or on the headphone.

22. The headphone according to claim 20 comprising an audio player for reproducing the stored audio data.

23. The headphone according to claim 22 wherein the audio player is an MP3 player.
